(19) United States
(12) Patent Application Publication
(10) Pub. No.: US 2018/0351588 A1
(43) Pub. Date: Dec. 6, 2018

(54) CANCELLATION DEVICE, CANCELLATION METHOD, AND WIRELESS COMMUNICATION APPARATUS

(71) Applicant: FUJITSU LIMITED, Kawasaki-shi (JP)

(72) Inventor: Kohei Ohta, Kawasaki (JP)

(73) Assignee: FUJITSU LIMITED, Kawasaki-shi (JP)

(21) Appl. No.: 15/996,564

(22) Filed: Jun. 4, 2018

(30) Foreign Application Priority Data
Jun. 6, 2017 (JP) 2017-111259

(51) Int. Cl. H04B 1/04; H04B 1/00

(52) U.S. Cl. CPC H04B 1/0475; H04B 2001/0433; H04B 1/0064

(57) ABSTRACT

There is provided a cancellation device including a memory, and a processor coupled to the memory and the processor configured to acquire a plurality of transmission signals to be wirelessly transmitted having mutually different frequencies, acquire a reception signal to which a plurality of inter-modulated signals generated by the plurality of transmission signals wirelessly transmitted are added, update a correction coefficient based on a signal obtained by combining a cancellation signal, to be applied to the reception signal, with an inter-modulated signal of the plurality of inter-modulated signals included in the reception signal, and a replica signal of the inter-modulated signal generated by the plurality of transmission signals, apply the correction coefficient to the replica signal so as to generate the cancellation signal, and initialize the correction coefficient based on a relationship between the cancellation signal and the reception signal.

### CROSS-REFERENCE TO RELATED APPLICATION

This application is based upon and claims the benefit of priority of the prior Japanese Patent Application No. 2017-111259, filed on Jun. 6, 2017, the entire contents of which are incorporated herein by reference.

### FIELD

The embodiments discussed herein are related to a cancellation device, a cancellation method, and a wireless communication apparatus.

### BACKGROUND

A plurality of wireless communication apparatuses can communicate with each other using different frequencies without interfering with each other. Further, in a wireless communication apparatus using an FDD (Frequency Division Duplex) scheme, since a frequency band used for a transmission signal is different from a frequency band used for a reception signal, the transmission and the reception can be performed in parallel. Further, there has been known a technique in which wireless communication apparatuses communicate with each other using a plurality of carriers each having different frequencies, such as carrier aggregation.

In the meantime, when a communication is performed using a plurality of transmission signals each having different frequencies, there are some cases where the plurality of transmission signals are inter-modulated by, for example, the reflection on an obstacle such as a metal signboard and the inter-modulated signals are received by each wireless communication apparatus. Depending on the arrangement of the frequencies of the transmission signals, the frequency of the inter-modulated signal may be included in the reception band which is the frequency band of the reception signal. When the frequency of the inter-modulated signal is close to the frequency of the reception signal, the inter-modulated signal is not completely removed by, for example, a filtering, which may result in a deterioration of the quality of the reception signal in the wireless communication apparatus.

Thus, it has been being studied to generate a cancellation signal corresponding to an inter-modulated signal from a plurality of transmission signals and combine the generated cancellation signal with a reception signal, so as to cancel the inter-modulated signal included in the reception signal. For example, a replica of an inter-modulated signal is approximately generated from a baseband transmission signal, and a cancellation signal is generated by multiplying the generated replica by a correction coefficient. Then, the cancellation signal and the reception signal are combined with each other, and the correction coefficient is updated so that a component of the inter-modulated signal included in the combined signal becomes small.

Related technologies are disclosed in, for example, Japanese National Publication of International Patent Application No. 2009-526442.

### SUMMARY

According to an aspect of the invention, a cancellation device includes a memory, and a processor coupled to the memory and the processor configured to acquire a plurality of transmission signals to be wirelessly transmitted having mutually different frequencies, acquire a reception signal to which a plurality of inter-modulated signals generated by the plurality of transmission signals wirelessly transmitted are added, update a correction coefficient based on a signal obtained by combining a cancellation signal, to be applied to the reception signal, with an inter-modulated signal of the plurality of inter-modulated signals included in the reception signal, and a replica signal of the inter-modulated signal generated by the plurality of transmission signals, apply the correction coefficient to the replica signal so as to generate the cancellation signal, and initialize the correction coefficient based on a relationship between the cancellation signal and the reception signal.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a block diagram illustrating an example of a base station apparatus;

FIG. 2 is a block diagram illustrating an example of an RE (Radio Equipment);

FIG. 3 is a block diagram illustrating an example of a function of a processor of a cancellation device according to a first embodiment;

FIG. 4 is a view for explaining an example of a PIM signal;

FIG. 5 is a view for explaining another example of the PIM signal;

FIG. 6 is a flowchart illustrating an example of an operation of a base station apparatus;

FIG. 7 is a flowchart illustrating an example of an abnormality determination process according to the first embodiment;

FIG. 8 is a flowchart illustrating another example of the abnormality determination process according to the first embodiment;

FIG. 9 is a block diagram illustrating an example of a function of a processor of a cancellation device according to a second embodiment;

FIG. 10 is a flowchart illustrating an example of an abnormality determination process according to the second embodiment;

FIG. 11 is a block diagram illustrating an example of a function of a processor of a cancellation device according to a third embodiment; and

FIG. 12 is a flowchart illustrating an example of an abnormality determination process according to the third embodiment.

### DESCRIPTION OF EMBODIMENTS

There is a case where a distortion compensation device is installed for compensating the nonlinearity of a power amplifier installed in a wireless communication apparatus. The distortion compensation device multiplies a transmission signal before being input to the power amplifier by a distortion compensation coefficient and sequentially updates the distortion compensation coefficient so that a difference between the output waveform of the power amplifier and the waveform of the transmission signal before being multiplied by the distortion compensation coefficient becomes small.

However, due to, for example, a sudden fluctuation in the power of the transmission signal or a sudden change in the surrounding environment such as a temperature, the updating of the distortion compensation coefficient may not be temporarily in time. In such a case, the transmission signal output from the power amplifier and the transmission signal before being multiplied by the distortion compensation coefficient have different waveforms. An inter-modulated signal generated by the transmission signal output from the power amplifier is superimposed on a reception signal. However, since the transmission signal output from the power amplifier is different in waveform from the transmission signal before being multiplied by the distortion compensation coefficient, it is difficult to cancel the inter-modulated signal superimposed on the reception signal with a cancellation signal generated from the transmission signal of the baseband. For example, combining the cancellation signal generated from the baseband transmission signal with the reception signal may deteriorate the quality of the reception signal reversely.

Hereinafter, embodiments of a technique capable of suppressing the deterioration of the reception quality will be described in detail with reference to the drawings. In addition, the disclosed technique is not limited by the embodiments. In addition, the embodiments may be appropriately combined with each other in the scope that does not cause any inconsistency in processes.

### First Embodiment

[Base Station Apparatus 10]

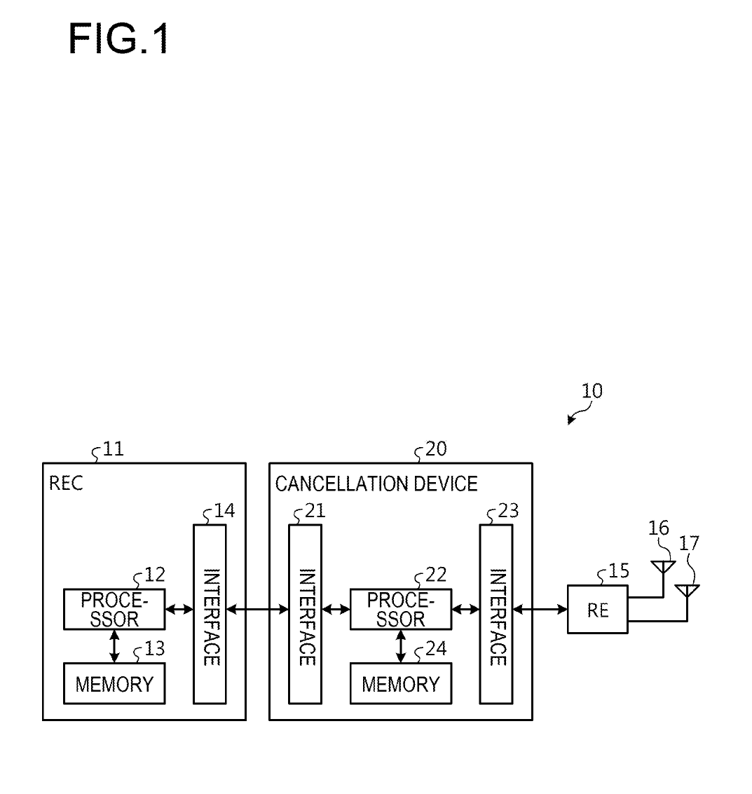

FIG. 1 is a block diagram illustrating an example of a base station apparatus 10. The base station apparatus 10 includes an REC (Radio Equipment Control) 11, a cancellation device 20, and an RE (Radio processing Equipment) 15. While FIG. 1 represents that the base station apparatus 10 includes one RE 15, the base station apparatus 10 may include more REs 15 which may be connected to the REC 11 via the cancellation device 20. The base station apparatus 10 is an example of a wireless communication apparatus.

The REC 11 executes a baseband process and transmits a baseband transmission signal including transmission data to the cancellation device 20. In addition, the REC 11 receives a baseband reception signal including the reception data from the cancellation device 20 and executes a baseband process on the received reception signal. Specifically, the REC 11 includes a processor 12, a memory 13, and an interface 14.

The processor 12 includes, for example, a CPU (Central Processing Unit), an FPGA (Field Programmable Gate Array), or a DSP (Digital Signal Processor), and generates the transmission signal transmitted from the RE 15. In the present embodiment, the RE 15 has two antennas 16 and 17 from which transmission signals with different frequencies f1 and f2 are respectively transmitted. The processor 12 generates the transmission signals Tx1 and Tx2 transmitted from the two antennas 16 and 17 of the RE 15, respectively. The transmission signal Tx1 is transmitted at, for example, the frequency f1, and the transmission signal Tx2 is transmitted at, for example, the frequency f2. In addition, the processor 12 obtains the reception data from the reception signal received by the RE 15.

In addition, the processor 12 transmits signal information including information on the transmission signal and the reception signal to the cancellation device 20. The signal information includes information such as frequencies and bandwidths of the transmission signals Tx1 and Tx2 and the reception signal.

The memory 13 is equipped with, for example, a RAM (Random Access Memory) or a ROM (Read Only Memory) and stores information used by the processor 12 to execute a process.

The interface 14 is connected to the cancellation device 20 via a cable such as, for example, an optical fiber. The interface 14 transmits the transmission signal and the signal information to the cancellation device 20 and receives the reception signal from the cancellation device 20. The transmission signal transmitted from the interface 14 to the cancellation device 20 includes the above-described transmission signals Tx1 and Tx2.

The cancellation device 20 is connected between the REC 11 and the RE 15. The cancellation device 20 relays the transmission signal and the signal information transmitted from the REC 11 to the RE 15. In addition, the cancellation device 20 relays the reception signal transmitted from the RE 15 to the REC 11. In addition, the cancellation device 20 generates a cancellation signal corresponding to the inter-modulated signal generated by inter-modulation of the transmission signals Tx1 and Tx2, based on the transmission signals Tx1 and Tx2, and combines the cancellation signal with the reception signal. In the following description, the inter-modulated signal will be referred to as a PIM (Passive Inter-Modulation) signal. Further, in the present embodiment, it is assumed that the transmission signals Tx1 and Tx2 transmitted from RE 15 are irradiated to a distortion generating source so that the PIM signal is generated, and the frequency of the generated PIM signal is included in a reception band of the RE 15. The cancellation device 20 cancels the PIM signal generated by the inter-modulation of the transmission signals Tx1 and Tx2 from the reception signal by combining the cancellation signal with the reception signal. Specifically, the cancellation device 20 includes an interface 21, a processor 22, an interface 23, and a memory 24.

The interface 21 is connected to the REC 11 via a cable such as an optical fiber. The interface 21 receives the transmission signal and the signal information from the interface 14 of the REC 11. Further, the interface 21 transmits the reception signal received by the RE 15 to the interface 14 of the REC 11.

The processor 22 is equipped with, for example, a CPU, an FPGA, or a DSP, and generates a cancellation signal for canceling the PIM signal, based on the transmission signal and the signal information received by the interface 21. In addition, the processor 22 combines the cancellation signal with the reception signal received by the interface 23, and cancels the PIM signal included in the reception signal. The detailed function of the processor 22 will be described later.

The memory 24 is equipped with, for example, a RAM or a ROM and stores information used by the processor 22 to execute a process. That is, the memory 24 stores, for example, parameters used by the processor 22 to generate the cancellation signal.

The interface 23 is connected to the RE 15 via a cable such as, for example, an optical fiber. The interface 23 transmits, to the RE 15, the transmission signal and the signal information transmitted from the REC 11 and receives, from the RE 15, the reception signal received by the RE 15. The transmission signal transmitted from the interface 23 to the RE 15 includes the transmission signals Tx1 and Tx2 described above. The reception signal received by the interface 23 from the RE 15 includes the PIM signal generated by the inter-modulation of the transmission signal of the frequency f1 and the transmission signal of the frequency f2.

The RE 15 is connected to the cancellation device 20 via a cable such as, for example, an optical fiber. The RE 15 receives the transmission signal and the signal information transmitted from the cancellation device 20. Then, the RE 15 converts the transmission signals Tx1 and Tx2 received from the cancellation device 20 from a digital signal to an analog signal. Then, the RE 15 up-converts the transmission signals Tx1 and Tx2 to predetermined frequencies f1 and f2, respectively, based on the signal information. Then, the RE 15 amplifies the up-converted transmission signals Tx1 and Tx2. Then, the RE 15 transmits the amplified transmission signals Tx1 and Tx2 to the space from the two antennas 16 and 17, respectively.

In the present embodiment, the RE 15 includes a power amplifier for amplifying the transmission signals Tx1 and Tx2 and a distortion compensation device for compensating for the nonlinearity of the power amplifier. The RE 15 may further include, for example, a CFR (Crest Factor Reduction) circuit for suppressing the peak power of the baseband signal received from the cancellation device 20.

Further, the RE 15 amplifies the reception signal received via the antennas 16 and 17. Then, based on the signal information, the RE 15 down-converts the reception signal of a predetermined frequency band in the amplified reception signal to a baseband. Then, the RE 15 converts the down-converted reception signal from an analog signal to a digital signal and outputs the converted signal to the cancellation device 20. The reception signal output from the RE 15 to the cancellation device 20 includes the PIM signal generated by the inter-modulation of the transmission signal of the frequency f1 and the transmission signal of the frequency f2 described above. The RE 15 is an example of a transmitting unit and a receiving unit. While FIG. 1 represents the example where two antennas 16 and 17 are installed in the RE 15, three or more antennas may be installed in the RE 15. Further, while FIG. 1 represents that the base station apparatus 10 has one RE 15, the base station apparatus 10 may have two or more REs 15.

[RE 15]

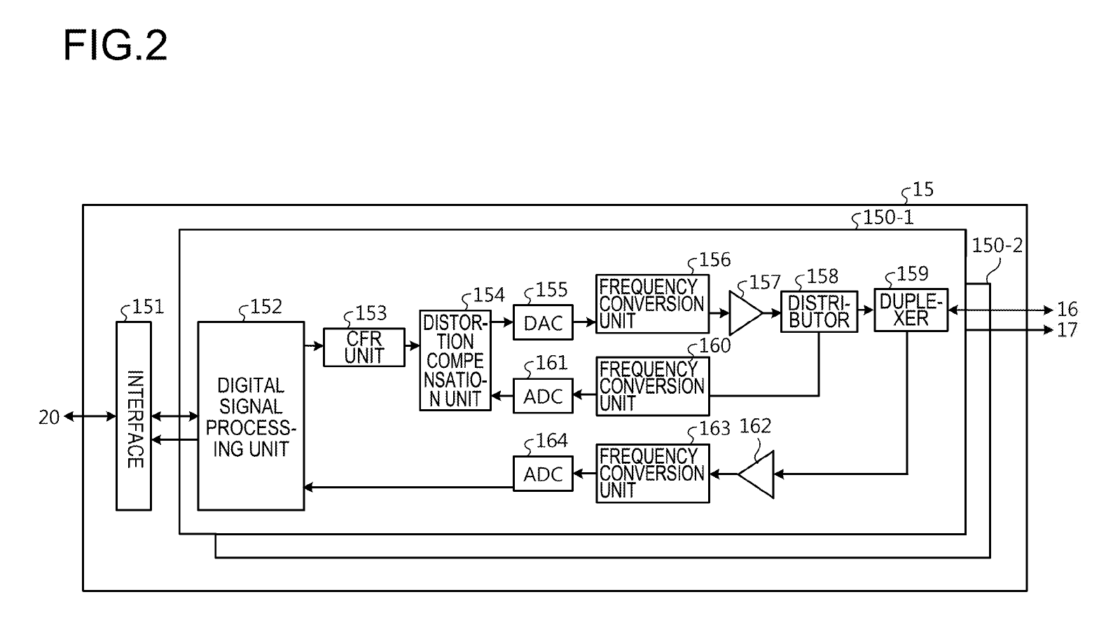

FIG. 2 is a block diagram illustrating an example of the RE 15. The RE 15 includes an interface 151, a radio section 150-1, and a radio section 150-2. In the present embodiment, the radio section 150-1 is connected to the antenna 16 and the radio section 150-2 is connected to the antenna 17. The interface 151 outputs the transmission signal and the signal information, which are output from the cancellation device 20, to each of the radio sections 150-1 and 150-2. For example, the interface 151 outputs to the radio section 150-1 the transmission signal Tx1 and the signal information output from the cancellation device 20, and outputs to the radio section 150-2 the transmission signal Tx2 and the signal information output from the cancellation device 20.

The radio section 150-1 includes a digital signal processing unit 152, a CFR unit 153, a distortion compensation unit 154, a DAC (Digital to Analog Converter) 155, a frequency conversion unit 156, a PA (Power Amplifier) 157, a distributor 158, and a duplexer 159. The radio section 150-1 further includes a frequency conversion unit 160, an ADC (Analog to Digital Converter) 161, an LNA (Low Noise Amplifier) 162, a frequency conversion unit 163, and an ADC 164. The PA 157 is an example of a power amplifier that amplifies a transmission signal. FIG. 2 represents the internal configuration of the radio section 150-1 connected to the antenna 16, and descriptions of the internal configuration of the radio section 150-2 connected to the antenna 17 will be omitted because the internal configuration of the radio section 150-2 is the same as that of the radio section 150-1.

The digital signal processing unit 152 performs a sampling rate converting process and a filtering process on the transmission signal output from the interface 151. In addition, the digital signal processing unit 152 performs a sampling rate converting process and a filtering process on the reception signal output from the ADC 164.

The CFR unit 153 suppresses the peak power of the transmission signal output from the digital signal processing unit 152. The distortion compensation unit 154 imparts the inverse characteristic of a distortion generated in the PA 157 to the transmission signal output from the CFR unit 153. Specifically, the distortion compensation unit 154 uses the transmission signal output from the CFR unit 153 and the transmission signal that is fed back through the distributor 158, the frequency conversion unit 160, and the ADC 161 to generate a distortion of the inverse characteristic of the distortion generated in the PA 157.

The duplexer 159 outputs the transmission signal output from the distributor 158 to the antenna 16. Further, the duplexer 159 outputs the reception signal received via the antenna 16 to the LNA 162. The LNA 162 amplifies the power of the reception signal and outputs the power-amplified reception signal to the frequency conversion unit 163. The frequency conversion unit 163 converts the frequency of the reception signal to a desired frequency and outputs the frequency-converted reception signal to the digital signal processing unit 152 via the ADC 164.

[Processor 22 of Cancellation Device 20]

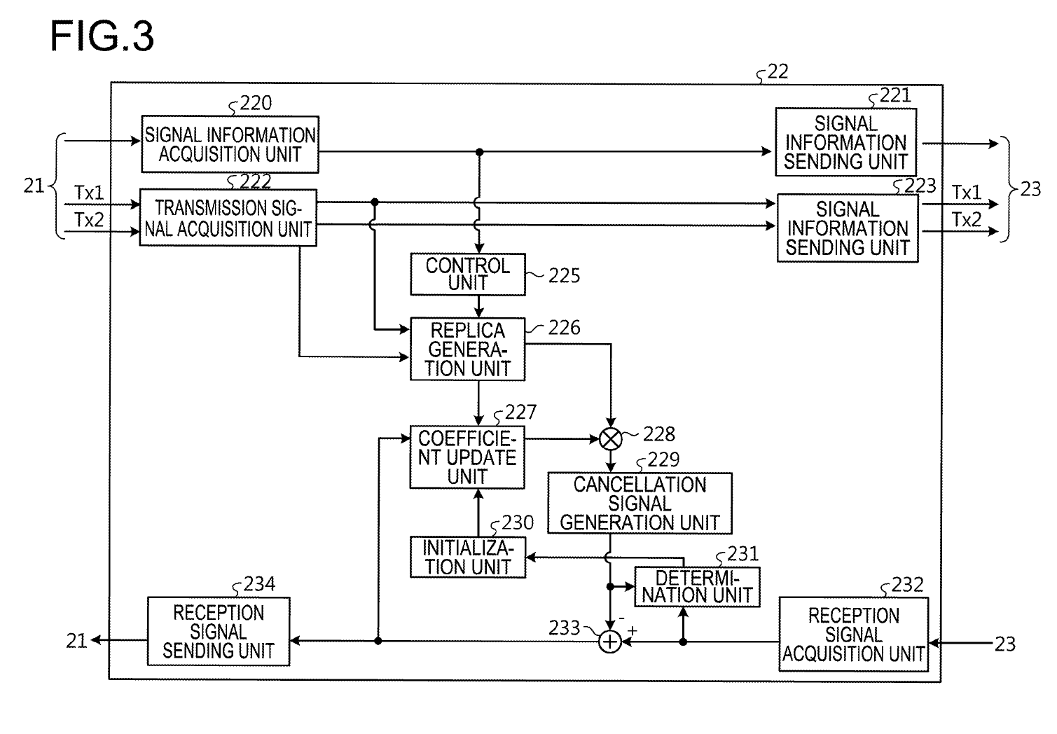

FIG. 3 is a block diagram illustrating an example of the function of the processor 22 of the cancellation device 20 in the first embodiment. The processor 22 includes a signal information acquisition unit 220, a signal information sending unit 221, a transmission signal acquisition unit 222, a transmission signal sending unit 223, a control unit 225, and a replica generation unit 226. The processor 22 further includes a coefficient update unit 227, a multiplication unit 228, a cancellation signal generation unit 229, an initialization unit 230, a determination unit 231, a reception signal acquisition unit 232, a combining unit 233, and a reception signal sending unit 234.

The signal information acquisition unit 220 acquires signal information transmitted from the REC 11 via the interface 21. Then, the signal information acquisition unit 220 outputs the acquired signal information to the signal information sending unit 221 and the control unit 225. The signal information sending unit 221 outputs the signal information acquired by the signal information acquisition unit 220 to the RE 15 via the interface 23.

The transmission signal acquisition unit 222 acquires the transmission signals Tx1 and Tx2 transmitted from the REC 11 via the interface 21. Then, the transmission signal acquisition unit 222 outputs the acquired transmission signals Tx1 and Tx2 to the transmission signal sending unit 223 and the replica generation unit 226. The transmission signal sending unit 223 outputs the transmission signals Tx1 and Tx2 acquired by the transmission signal acquisition unit 222 to the RE 15 via the interface 23.

Based on the signal information output from the signal information acquisition unit 220, the control unit 225 specifies a PIM signal whose frequency band overlaps with at least a portion of the reception band. Then, the control unit 225 specifies a generation formula for generating a replica of the PIM signal for each specified PIM signal. Then, the control unit 225 outputs the generation formula specified for each replica to the replica generation unit 226.

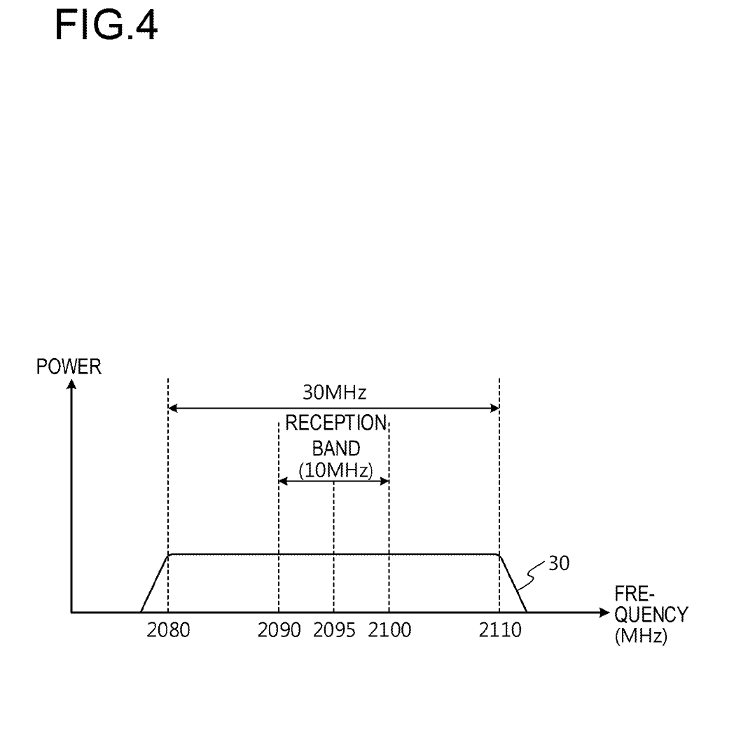

FIG. 4 is a view for explaining an example of the PIM signal. A spectrum 30 illustrated in FIG. 4 is a frequency spectrum of a PIM signal corresponding to a frequency 2f1-f2 among third-order PIM signals, for example, when the frequency f1 of the transmission signal Tx1 is 2135 MHz and the frequency f2 of the transmission signal Tx2 is 2175 MHz. In the example of FIG. 4, it is assumed that the frequency band of each of the transmission signals Tx1 and Tx2 is, for example, 10 MHz, and the reception band is, for example, a frequency band of 10 MHz centered on 2,095 MHz. Since the frequency band of each of the transmission signals Tx1 and Tx2 is, for example, 10 MHz, the frequency band of a third-order PIM signal generated from the transmission signals Tx1 and Tx2 is 30 MHz.

In the example of FIG. 4, the reception band overlaps with a portion of the frequency band of the PIM signal corresponding to the frequency 2f1-f2. In the example of FIG. 4, based on the signal information output from the signal information acquisition unit 220, the control unit 225 specifies the PIM signal corresponding to the frequency 2f1-f2 as a PIM signal whose frequency band overlaps with at least a portion of the reception band. Then, the control unit 225 specifies, for example, the following generation formula (1) as a generation formula for generating a replica of the PIM signal corresponding to the frequency 2f1-f2. Then, the control unit 225 outputs the specified generation formula (1) to the replica generation unit 226.

Tx1×Tx1×conj(Tx2) (1)
In the generation formula (1) above, conj(Tx2) indicates the complex conjugate of the transmission signal Tx2.

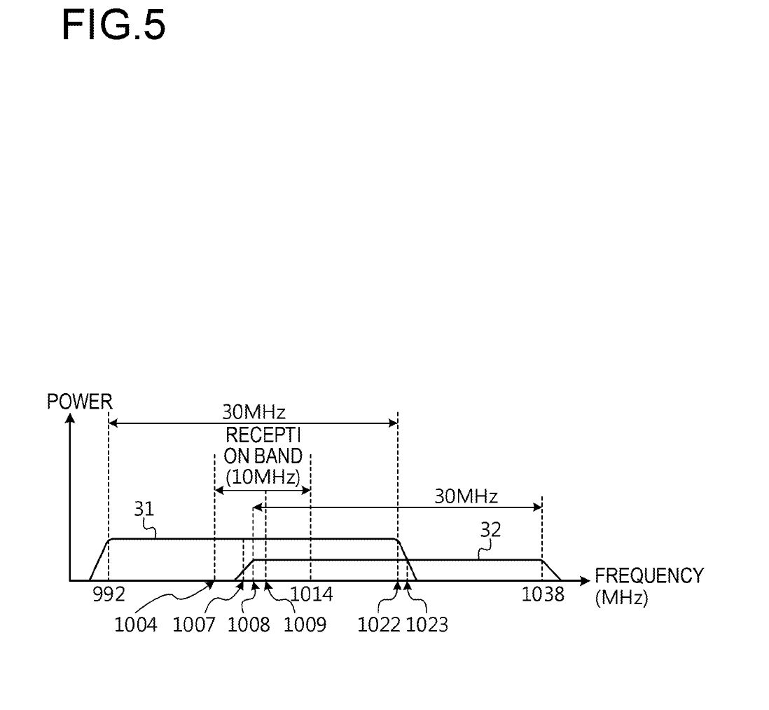

FIG. 5 is a view for explaining another example of the PIM signal. A spectrum 31 illustrated in FIG. 5 is a frequency spectrum of a PIM signal corresponding to a frequency 2f1-f2 among third-order PIM signals, for example, when the frequency f1 of the transmission signal Tx1 is 1,023 MHz and the frequency f2 of the transmission signal Tx2 is 1,039 MHz. In addition, a spectrum 32 illustrated in FIG. 5 is a frequency spectrum of a PIM signal corresponding to a frequency f1 among third-order PIM signals, for example, when the frequency f1 of the transmission signal Tx1 is 1,023 MHz and the frequency f2 of the transmission signal Tx2 is 1,039 MHz. In the example of FIG. 5, it is assumed that the frequency band of each of the transmission signals Tx1 and Tx2 is, for example, 10 MHz and the reception band is, for example, a frequency band of 10 MHz centered on 1,009 MHz.

In the example of FIG. 5, the reception band overlaps with a portion of the frequency band of the PIM signal corresponding to the frequency 2f1-f2. In addition, in the example of FIG. 5, a portion of the reception band overlaps with a portion of the frequency band of the PIM signal corresponding to the frequency f1. In the example of FIG. 5, based on the signal information output from the signal information acquisition unit 220, the control unit 225 specifies the PIM signal corresponding to frequency 2f1-f2 and the PIM signal corresponding to frequency f1 as PIM signals whose frequency bands overlap with at least a portion of the reception band. Then, the control unit 225 specifies, for example, the above-mentioned generation formula (1) as a generation formula for generating a replica of the PIM signal corresponding to the frequency 2f1-f2.

In addition, the control unit 225 specifies, for example, the following generation formulas (2) and (3) as generation formulas for generating a replica of the PIM signal corresponding to the frequency f1. Then, the control unit 225 outputs the specified generation formulas (1) to (3) to the replica generation unit 226 for each replica of the PIM signal.

Tx1×Tx1×conj(Tx1) (2)

Tx1×Tx2×conj(Tx2) (3)

Referring back to FIG. 3, the replica generation unit 226 receives the transmission signals Tx1 and Tx2 from the transmission signal acquisition unit 222 and receives the generation formula for each replica from the control unit 225. Then, the replica generation unit 226 generates a replica of the PIM signal based on the generation formula output from the control unit 225 for each replica. Then, the replica generation unit 226 outputs the generated replica to the coefficient update unit 227 and the multiplication unit 228.

The coefficient update unit 227 updates a correction coefficient applied to the replica based on the reception signal combined with a cancellation signal to be described later, for each replica output from the replica generation unit 226. Specifically, the coefficient update unit 227 updates the correction coefficient for each replica so that a value of a correlation between the replica and the reception signal combined with the cancellation signal becomes small. For example, the coefficient update unit 227 uses, for example, an LMS (Least Mean Square) algorithm to sequentially update a value of the following calculation formula (4) as a correction coefficient for each replica.

$${\sum }_{i = 0}^{N} \{ {Rep}_{i} \times conj ( {R}_{i}^{′} ) \times μ \} \qquad ( 4 )$$

In the above calculation formula (4), Rep, represents a replica in sample i and Rᵢ′ represents a reception signal in sample i after the cancellation signal is combined. Further, in the above calculation formula (4), μ represents a step size and N represents a predetermined number of samples. Further, in the above calculation formula (4), a value smaller than 1, for example, 0.5, is set for μ.

The coefficient update unit 227 outputs the updated correction coefficient to the multiplication unit 228 for each replica. In addition, when receiving an initialization instruction from the initialization unit 230, the coefficient update unit 227 initializes all the correction coefficients updated for each replica to a predetermined value. In the present embodiment, the predetermined value is, for example, a correction coefficient with amplitude and phase values of 0. Then, the coefficient update unit 227 resumes updating the correction coefficient for each replica from the initialized value. The coefficient update unit 227 is an example of an update unit.

The multiplication unit 228 receives the replica from the replica generation unit 226 and receives the correction coefficient for each replica from the coefficient update unit 227. Then, the multiplication unit 228 multiplies the replica by the correction coefficient for each replica. Then, each replica multiplied by the correction coefficient is output to the cancellation signal generation unit 229. The multiplication unit 228 is, for example, a complex multiplier.

The cancellation signal generation unit 229 generates a cancellation signal including each replica multiplied by the correction coefficient by the multiplication unit 228. Specifically, the cancellation signal generation unit 229 adds each replica multiplied by the correction coefficient by the multiplication unit 228 to generate the cancellation signal. Then, the cancellation signal generation unit 229 outputs the generated cancellation signal to the combining unit 233. The cancellation signal generation unit 229 is an example of a generation unit.

The reception signal acquisition unit 232 acquires the reception signal output from the RE 15 via the interface 23. The reception signal acquired by the reception signal acquisition unit 232 includes the PIM signal generated by the inter-modulation of the transmission signals Tx1 and Tx2.

The combining unit 233 combines the cancellation signal output from the cancellation signal generation unit 229 with the reception signal acquired by the reception signal acquisition unit 232. That is, the combining unit 233 cancels the PIM signal from the reception signal by combining the reception signal including the PIM signal and the cancellation signal with each other.

The reception signal sending unit 234 sends the reception signal combined with the cancellation signal to the REC 11 via the interface 21.

The determination unit 231 determines whether or not the cancellation signal is abnormal (non-effective), at every predetermined timing. In the present embodiment, when the power of the reception signal acquired by the reception signal acquisition unit 232 is equal to or lower than the power of the cancellation signal output from the cancellation signal generation unit 229, the determination unit 231 determines that the cancellation signal is abnormal. Then, the determination unit 231 outputs the determination result to the initialization unit 230. In the present embodiment, when the number of times of making the determination that the cancellation signal is abnormal reaches a predetermined number of times during a predetermined period of time, the determination unit 231 outputs a determination result indicating the abnormality of the cancellation signal to the initialization unit 230.

Here, the reception signal includes a signal transmitted from a terminal device to the base station apparatus 10, in addition to the PIM signal. Therefore, the total power of the reception signal is greater than the power of the PIM signal. Further, when an operation abnormality (non-effectiveness) occurs due to a large fluctuation of an input signal in the distortion compensation device in the RE 15, a nonlinear component occurs as a large distortion in the vicinity of the signal band of the transmission signals Tx1 and Tx2 transmitted from the RE 15. The transmission signals Tx1 and Tx2 and the inter-modulated signal generated from the above-mentioned distortion have signal components different from the inter-modulated signal generated from the waveforms of the transmission signals Tx1 and Tx2 having no distortion output from the REC 11. As a result, even when the cancellation signal generated by the cancellation signal generation unit 229 is combined with the reception signal, the PIM signal in the reception signal is not removed.

In addition, the amplitude of the correction coefficient updated by the coefficient update unit 227 may become larger than the optimal amplitude due to the influence of distortion occurring in the vicinity of the signal band of the transmission signals Tx1 and Tx2. Therefore, the power of the cancellation signal combined with a replica signal multiplied by the correction coefficient may be increased to exceed the power of the reception signal. When the power of the cancellation signal becomes too large, the quality of a signal included in the reception signal and transmitted from the terminal device to the base station apparatus 10 is deteriorated as the reception signal is combined with the cancellation signal. Therefore, when the power of the cancellation signal is equal to or larger than the power of the reception signal, the determination unit 231 in the present embodiment determines that the cancellation signal is abnormal.

In response to receiving the determination result indicating the abnormality of the cancellation signal from the determination unit 231, the initialization unit 230 outputs to the coefficient update unit 227 the initialization instruction instructing initialization of the correction coefficient updated for each replica. Upon receiving the initialization instruction from the initialization unit 230, the coefficient update unit 227 initializes the correction coefficient for each replica and resumes updating the correction coefficient for each replica from the initialized value. As a result, the updating of the correction coefficient that has become an abnormal value is reset, and the power of the cancellation signal combined with the reception signal is reduced again. This makes it possible to improve the quality of a signal included in the reception signal combined with the cancellation signal and transmitted from the terminal device to the base station apparatus 10.

[Operation of Base Station Apparatus 10]

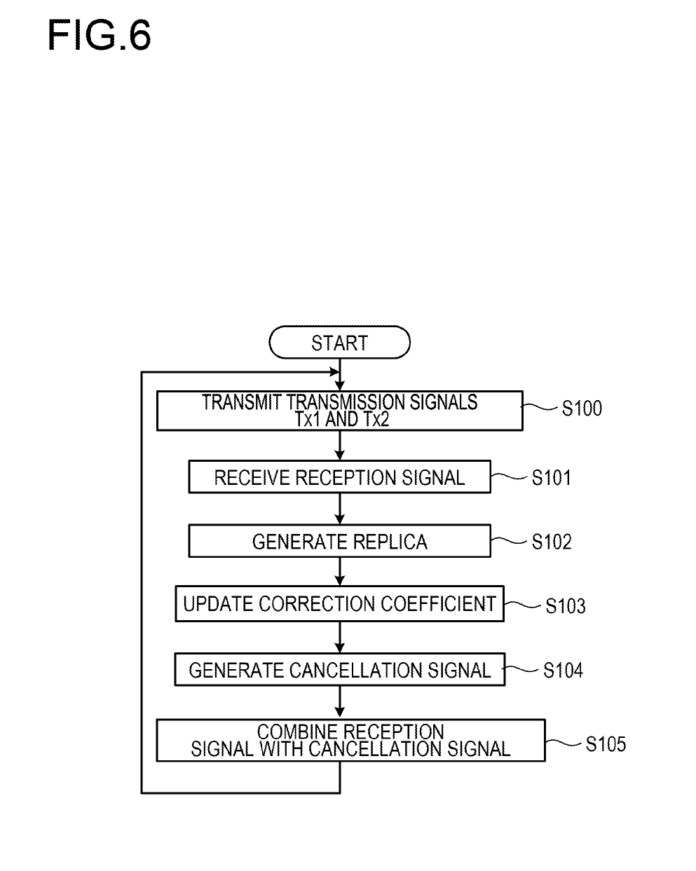

FIG. 6 is a flowchart illustrating an example of the operation of the base station apparatus 10. For example, when the operation is started, the base station apparatus 10 starts the operation illustrated in this flowchart.

First, the base station apparatus 10 transmits the transmission signals Tx1 and Tx2 (S100). Specifically, the REC 11 generates the transmission signals Tx1 and Tx2 and the signal information. Then, the REC 11 outputs the generated transmission signals Tx1 and Tx2 and signal information to the cancellation device 20.

The signal information acquisition unit 220 of the cancellation device 20 acquires the signal information output from the REC 11 and outputs the acquired signal information to the signal information sending unit 221 and the control unit 225. The signal information sending unit 221 outputs the signal information acquired by the signal information acquisition unit 220 to the RE 15. The transmission signal acquisition unit 222 of the cancellation device 20 acquires the transmission signals Tx1 and Tx2 transmitted from the REC 11 and outputs the acquired transmission signals Tx1 and Tx2 to the transmission signal sending unit 223 and the replica generation unit 226. The transmission signal sending unit 223 outputs the transmission signals Tx1 and Tx2 acquired by the transmission signal acquisition unit 222 to the RE 15.

The RE 15 receives the transmission signals Tx1 and Tx2 and the signal information output from the cancellation device 20. Then, the RE 15 converts the transmission signals Tx1 and Tx2 received from the cancellation device 20 from a digital signal to an analog signal. Then, the RE 15 up-converts the transmission signals Tx1 and Tx2 to predetermined frequencies f1 and f2, respectively, based on the signal information. Then, the RE 15 amplifies the up-converted transmission signals Tx1 and Tx2. Then, the RE 15 transmits the amplified transmission signals Tx1 and Tx2 from each of the two antennas to the space.

Next, the base station apparatus 10 receives the reception signal (S101). Specifically, the RE 15 amplifies the reception signal received via the antenna. Then, based on the signal information, the RE 15 down-converts a reception signal included in the reception band among the amplified reception signals to a baseband. Then, the RE 15 converts the down-converted reception signal from an analog signal to a digital signal and outputs the converted signal to the cancellation device 20. The reception signal acquisition unit 232 of the cancellation device 20 acquires the reception signal output from the RE 15 and outputs the acquired reception signal to the determination unit 231 and the combining unit 233.

Next, the replica generation unit 226 of the cancellation device 20 generates a replica of the PIM signal by using the transmission signals Tx1 and Tx2 (S102). Specifically, the replica generation unit 226 receives the transmission signals Tx1 and Tx2 from the transmission signal acquisition unit 222 and receives a generation formula for each replica from the control unit 225. Then, the replica generation unit 226 generates the replica of the PIM signal based on the generation formula output from the control unit 225 for each replica. Then, the replica generation unit 226 outputs the generated replica to the coefficient update unit 227 and the multiplication unit 228 for each replica.

Next, the coefficient update unit 227 updates the correction coefficient applied to each replica based on the reception signal combined with the cancellation signal and each replica (S103). Specifically, the coefficient update unit 227 receives the replica from the replica generation unit 226 and updates the correction coefficient in accordance with the above-mentioned calculation formula (4) for each received replica so that a value of correlation between the replica and the reception signal combined with the cancellation signal becomes small.

Next, the multiplication unit 228 multiplies the replica received from the replica generation unit 226 by the correction coefficient received from the coefficient update unit 227 for each replica. Then, the cancellation signal generation unit 229 adds each replica multiplied by the correction coefficient by the multiplication unit 228 so as to generate the cancellation signal (S104). The combining unit 233 combines the cancellation signal generated by the cancellation signal generation unit 229 with the reception signal acquired by the reception signal acquisition unit 232 (S105). The reception signal combined with the cancellation signal is output to the coefficient update unit 227 and the REC 11. Then, the base station apparatus 10 again executes the process of the operation S100.

In the operation of the base station apparatus 10 illustrated in FIG. 6, the order of the processes of the operations S100 to S105 is not limited to the order illustrated in FIG. 6. For example, the processes of the operations S100 and S101 may be performed in parallel. Further, the process of the operation S103 may be performed independently from the processes of the operations S102 and S104.

[Abnormality Determination Process]

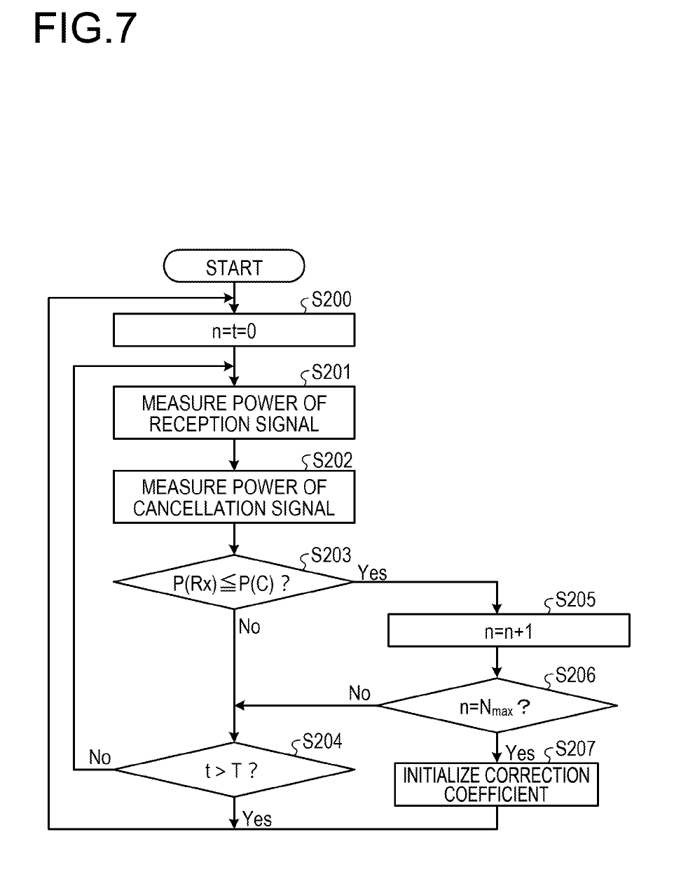

FIG. 7 is a flowchart illustrating an example of an abnormality determination process in the first embodiment. The abnormality determination process illustrated in FIG. 7 is executed by the cancellation device 20. For example, when the operation of the base station apparatus 10 is started, the cancellation device 20 starts the operation illustrated in this flowchart.

First, the determination unit 231 initializes a variable “n” for counting the number of errors and a timer value “t” to 0 (S200). The timer value “t” is sequentially incremented every predetermined time by a timer of the cancellation device 20. The determination unit 231 measures the power P (Rx) of the reception signal (S201). Further, the determination unit 231 measures the power P (C) of the cancellation signal generated by the cancellation signal generation unit 229 (S202).

Next, the determination unit 231 determines whether or not the cancellation signal is abnormal by determining whether or not the power P (Rx) of the reception signal is equal to or lower than the power P (C) of the cancellation signal (S203). When it is determined that the power P (Rx) of the reception signal is higher than the power P (C) of the cancellation signal (“No” in S203), that is, when the cancellation signal is normal, the determination unit 231 refers to the timer value “t” to determine whether the timer value “t” exceeds a value corresponding to a predetermined time T (S204).

When it is determined that the timer value “t” is equal to or smaller than the value corresponding to the predetermined time T (“No” in S204), the determination unit 231 again executes the process of the operation S201. Meanwhile, when it is determined that the timer value “t” exceeds the value corresponding to the predetermined time T (“Yes” in S204), the determination unit 231 again executes the process of the operation S200.

When it is determined that the power P (Rx) of the reception signal is equal to or lower than the power P (C) of the cancellation signal (“Yes” in S203), that is, when the cancellation signal is abnormal, the determination unit 231 increments a value of the variable “n” by 1 (S205). Then, the determination unit 231 determines whether or not the value of the variable “n” has reached a predetermined number of times Nmax (S206). When it is determined that the value of the variable “n” has not reached the predetermined number of times Nmax (No in S206), the determination unit 231 executes the process of the operation S204.

Meanwhile, when it is determined that the value of the variable “n” has reached the predetermined number of times Nmax (“Yes” in S206), the determination unit 231 outputs a determination result indicating the abnormality of the cancellation signal to the initialization unit 230. The initialization unit 230 outputs an initialization instruction to the coefficient update unit 227. Upon receiving the initialization instruction from the initialization unit 230, the coefficient update unit 227 initializes the correction coefficient of each replica (S207). Then, the coefficient update unit 227 resumes the updating of the correction coefficient for each replica from the initialized value. Then, the determination unit 231 again executes the process of the operation S200.

### Effects of First Embodiment

The first embodiment has been described. The base station apparatus 10 of the present embodiment includes the cancellation device 20 and the RE 15. The RE 15 transmits a plurality of transmission signals wirelessly transmitted at different frequencies. In addition, the RE 15 receives a reception signal including a PIM signal generated by the plurality of transmission signals. The cancellation device 20 includes the transmission signal acquisition unit 222, the reception signal acquisition unit 232, the coefficient update unit 227, the cancellation signal generation unit 229, the determination unit 231, and the initialization unit 230. The transmission signal acquisition unit 222 acquires the plurality of transmission signals wirelessly transmitted with different frequencies. The reception signal acquisition unit 232 acquires a reception signal including the PIM signal generated by the plurality of transmission signals. The coefficient update unit 227 updates a correction coefficient based on a signal obtained by combining the cancellation signal with the PIM signal included in the reception signal and a replica generated using the plurality of transmission signals. The cancellation signal generation unit 229 applies the correction coefficient to the replica so as to generate a cancellation signal. The determination unit 231 determines whether or not the cancellation signal is abnormal. The initialization unit 230 initializes the correction coefficient when the determination unit 231 determines that the cancellation signal is abnormal. As a result, the base station apparatus 10 may suppress deterioration of the reception quality.

Further, in the above embodiment, when the power of the cancellation signal is equal to or higher than the power of the reception signal, the determination unit 231 determines that the cancellation signal is abnormal. As a result, the base station apparatus 10 may suppress deterioration of the reception quality more accurately.

In the above embodiment, the initialization unit 230 initializes the correction coefficient when the determination unit 231 determines that the cancellation signal is abnormal, a predetermined number of times or more. Thus, the initialization of the correction coefficient due to the temporary lowering of the power of the reception signal is avoided. As a result, it is possible to suppress the fluctuation of the cancellation signal combined with the reception signal and to suppress the deterioration of the reception quality.

### Another Example

The abnormality of the cancellation signal determined by the determination unit 231 is caused by, for example, the operation abnormality of the distortion compensation device in the RE 15, which may continue for a predetermined time period. While, for example, the operation abnormality of the distortion compensating device is continuing, even when the updating of the initialized correction coefficient is resumed, it is again determined that the cancellation signal is abnormal. Therefore, when the determination unit 231 determines that the cancellation signal is abnormal, the initialization unit 230 may stop the updating of the correction coefficient by the coefficient update unit 227 for a predetermined time period. As a result, an unnecessary operation of the cancellation device 20 may be suppressed while, for example, the operation abnormality of the distortion compensation device is continuing.

While the updating of the correction coefficient by the coefficient update unit 227 is being stopped for a predetermined time period, the coefficient update unit 227 outputs the correction coefficient of 0 for each replica to the multiplication unit 228. As a result, the amplitude of each replica becomes 0 by the multiplication unit 228, and the amplitude of the cancellation signal generated by the cancellation signal generation unit 229 becomes 0. Therefore, the combining unit 233 outputs the reception signal acquired by the reception signal acquisition unit 232 to the reception signal sending unit 234 as it is.

In addition, while the updating of the correction coefficient by the coefficient update unit 227 is being stopped for a predetermined time period, the operations of the replica generation unit 226, the coefficient update unit 227, the multiplication unit 228, and the cancellation signal generation unit 229 may be stopped. In this case, the combining unit 233 outputs the reception signal acquired by the reception signal acquisition unit 232 to the reception signal transmission sending 234 as it is. As a result, it is possible to reduce the power consumption of the cancellation device 20 while the updating of the correction coefficient by the coefficient update unit 227 is being stopped for a predetermined time period.

[Abnormality Determination Process]

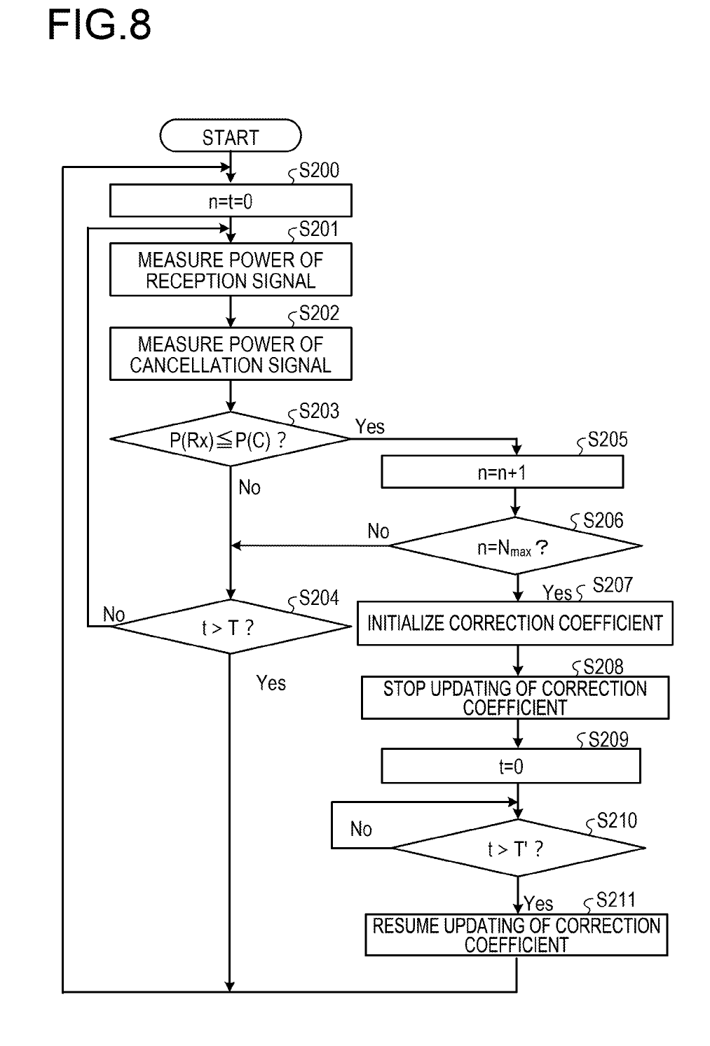

FIG. 8 is a flowchart illustrating another example of the abnormality determination process in the first embodiment. In FIG. 8, the processes denoted by the same reference numerals as used in FIG. 7 are the same as the processes described in FIG. 7, except for the points described below, and therefore, descriptions thereof will be omitted.

After the correction coefficient is initialized in the operation S207, the coefficient update unit 227 stops the updating of the correction coefficient (S208). Then, the initialization unit 230 initializes a timer value “t” to 0 (S209). Then, the initialization unit 230 refers to the timer value “t” to determine whether or not the timer value “t” exceeds a value corresponding to a predetermined time T′ (S210). When it is determined that the timer value “t” does not exceed the value corresponding to the predetermined time T′ (“No” in S210), the initialization unit 230 again executes the determination of the operation S210.

Meanwhile, when it is determined that the timer value “t” exceeds the value corresponding to the predetermined time T′ (“Yes” in S210), the initialization unit 230 instructs the coefficient update unit 227 to resume the updating of the correction coefficient. In accordance with the instruction from the initialization unit 230, the coefficient update unit 227 resumes the updating of the correction coefficient from the initialized value (S211). Then, the determination unit 231 again executes the process of the operation S200.

In this manner, when the determination unit 231 determines that the cancellation signal is abnormal, the initialization unit 230 stops the updating of the correction coefficient by the coefficient update unit 227 for a predetermined time period. Then, after the predetermined time period elapses, the initialization unit 230 resumes the operation of the coefficient update unit 227 from the value of the initialized correction coefficient. As a result, the cancellation device 20 may suppress an unnecessary operation of the cancellation device 20 while, for example, the operation abnormality of the distortion compensation device is continuing.

### Second Embodiment

When an operation abnormality occurs in, for example, the distortion compensation device in the RE 15, a difference between the waveforms of the transmission signals Tx1 and Tx2 transmitted from the RE 15 and the waveforms of the transmission signals Tx1 and Tx2 output from the REC 11 becomes large. In this case, even when the cancellation signal generated by the cancellation signal generation unit 229 is combined with the reception signal, not only the PIM signal in the reception signal is not removed, but also the cancellation signal remains in the reception signal combined with the cancellation signal. Therefore, a value of the correlation between the reception signal combined with the cancellation signal and each replica signal becomes large, and the amplitude component of the correction coefficient of each replica is updated to be large.

Therefore, in the present embodiment, the amplitude of the correction coefficient of each replica is monitored, and when the correction coefficient is equal to or larger than a predetermined threshold value, it is determined that the cancellation signal is abnormal.

[Processor 22 of Cancellation Device 20]

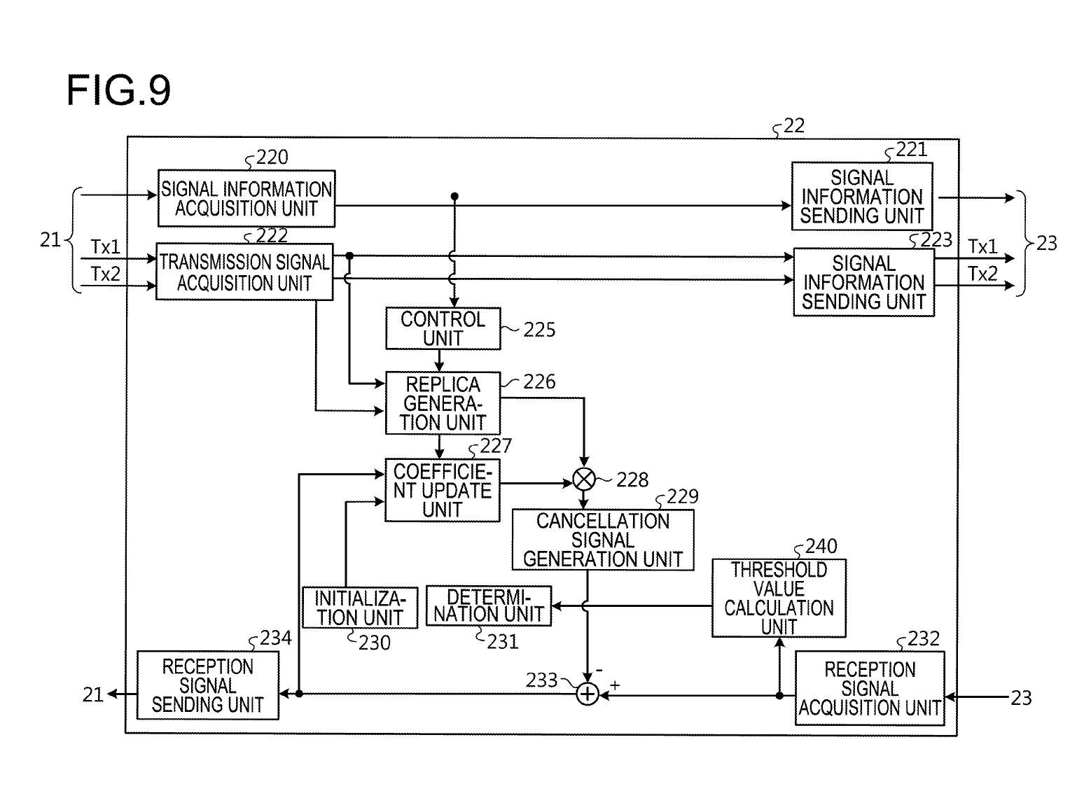

FIG. 9 is a block diagram illustrating an example of a function of a processor 22 of a cancellation device 20 in a second embodiment. The processor 22 in the present embodiment includes a signal information acquisition unit 220, a signal information sending unit 221, a transmission signal acquisition unit 222, a transmission signal sending unit 223, a control unit 225, and a replica generation unit 226. The processor 22 in the present embodiment further includes a coefficient update unit 227, a multiplication unit 228, a cancellation signal generation unit 229, an initialization unit 230, a determination unit 231, a reception signal acquisition unit 232, a combining unit 233, a reception signal transmission sending unit 234, and a threshold value calculation unit 240. In FIG. 9, blocks denoted by the same reference numerals as those in FIG. 3 have the same or similar functions as those illustrated in FIG. 3, except for the points described below, and thus, descriptions thereof will be omitted.

Based on the signal information output from the signal information acquisition unit 220, the control unit 225 specifies a PIM signal whose frequency band overlaps with at least a portion of the reception band. Then, the control unit 225 outputs a generation formula specified for each specified PIM signal to the replica generation unit 226. Further, the control unit 225 outputs information on the center frequency of the reception band and information on the center frequency of the frequency band of each PIM signal to the threshold value calculation unit 240.

The coefficient update unit 227 updates the correction coefficient applied to each replica output from the replica generation unit 226 based on the reception signal combined with the cancellation signal. Then, the coefficient update unit 227 outputs the updated correction coefficient for each replica to the multiplication unit 228 and the determination unit 231.

The determination unit 231 determines whether or not the cancellation signal is abnormal at every predetermined timing. In the present embodiment, the determination unit 231 acquires the correction coefficient for each replica from the coefficient update unit 227 at every predetermined timing and acquires a threshold value for each replica from the threshold value calculation unit 240. Then, the determination unit 231 determines whether or not the amplitude of the correction coefficient is equal to or larger than the threshold value acquired from the threshold value calculation unit 240 for each replica. In any of the replicas, when the amplitude of the correction coefficient is equal to or larger than the threshold value, the determination unit 231 determines that the cancellation signal is abnormal. Then, when the number of times of making the determination that the cancellation signal is abnormal reaches a predetermined number of times during a predetermined period of time, the determination unit 231 outputs the determination result indicating the abnormality of the cancellation signal to the initialization unit 230.

Based on the reception signal acquired by the reception signal acquisition unit 232 and the information on the center frequency of the frequency band of the PIM signal output from the control unit 225, the threshold value calculation unit 240 calculates a threshold value for determining the abnormality of the amplitude of the correction coefficient for each PIM signal. Then, the threshold value calculation unit 240 outputs the threshold value calculated for each PIM signal to the determination unit 231.

In the present embodiment, the threshold value calculation unit 240 calculates the amplitude of the reception signal as an initial value of the threshold value. Then, the threshold value calculation unit 240 calculates a weight according to a frequency difference between the center frequency of the frequency band of the PIM signal and the center frequency of the reception band (hereinafter, referred to as “detuning”). Then, the threshold value calculation unit 240 calculates a threshold value for each PIM signal by multiplying the initial value of the threshold value by the calculated weight. Accordingly, the threshold value corresponding to the PIM signal decreases as the detuning from the center frequency of the reception band increases.

Here, when a plurality of PIM signals are included in the reception signal, among the plurality of PIM signals, a PIM signal with larger detuning from the center frequency of the reception band has less influence on the reception signal. In other words, the coefficient update unit 227 updates the amplitude of the correction coefficient of the PIM signal with larger detuning from the center frequency of the reception band, to become smaller than the amplitude of the correction coefficient of a PIM signal with smaller detuning. Therefore, even when the amplitude of the correction coefficient corresponding to the PIM signal with larger detuning from the center frequency of the reception band is smaller than the amplitude of the correction coefficient corresponding to the PIM signal with smaller detuning, the amplitude of the correction coefficient corresponding to the PIM signal with large detuning may become a divergent or nearly divergent state. Therefore, the threshold value calculation unit 240 of the present embodiment calculates the threshold value of each PIM signal so that the threshold value corresponding to the PIM signal decreases as the detuning from the center frequency of the reception band increases. Then, the determination unit 231 determines whether or not the amplitude of the correction coefficient is equal to or larger than the threshold value for each replica of the PIM signal, by using the threshold value calculated by the threshold value calculation unit 240. As a result, the determination unit 231 may accurately determine whether or not the amplitude of the correction coefficient becomes the divergent or nearly divergent state.

In the present embodiment, the threshold value calculation unit 240 calculates the amplitude of the reception signal as the initial value of the threshold value, but the present disclosure is not limited thereto. For example, as another example, the threshold value calculation unit 240 may calculate an amplitude lower by a predetermined amount than the amplitude of the reception signal as the initial value of the threshold value. In addition, the threshold value calculation unit 240 may calculate the maximum value obtained from the bit width of the correction coefficient as the initial value of the threshold value. Further, even when a plurality of PIM signals are included in the reception band, the threshold value calculation unit 240 may uniformly apply the initial value of the threshold value to each PIM signal as a threshold value. Thus, the process of calculating the threshold value may be simplified.

[Abnormality Determination Process]

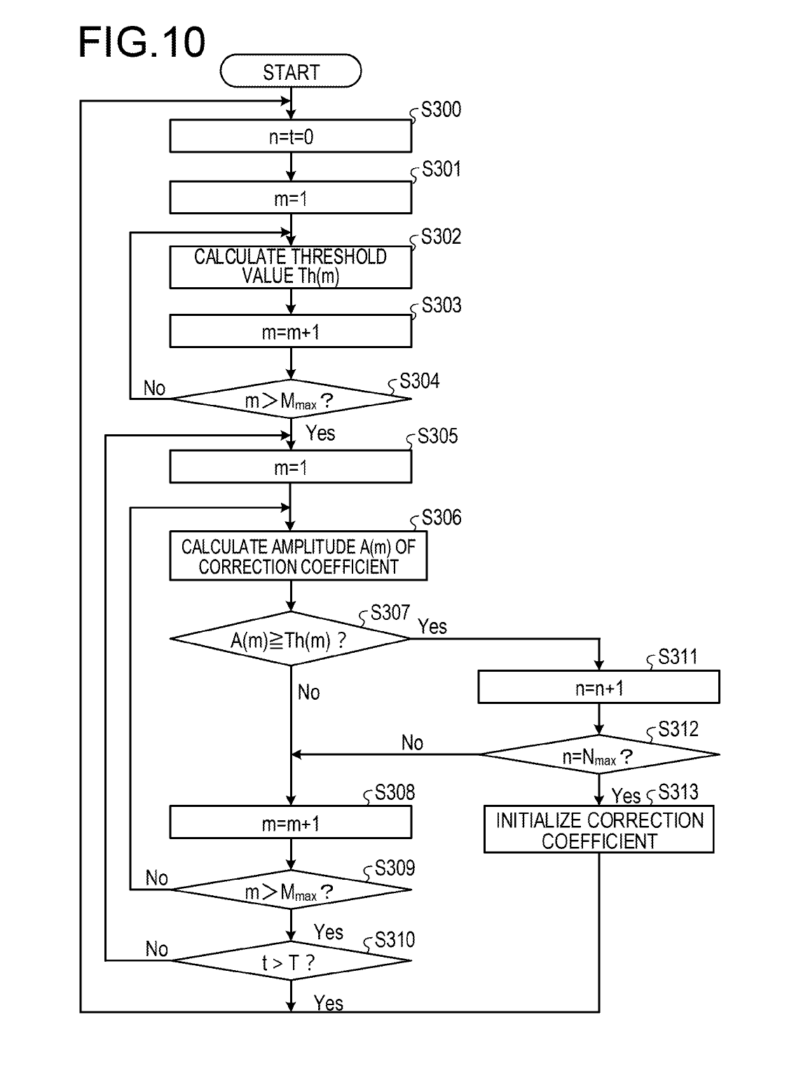

FIG. 10 is a flowchart illustrating an example of an abnormality determination process according to the second embodiment. The abnormality determination process illustrated in FIG. 10 is executed by the cancellation device 20. For example, when the operation of the base station apparatus 10 is started, the cancellation device 20 starts the operation illustrated in this flowchart.

First, the determination unit 231 initializes a variable “n” for counting the number of errors and a timer value “t” to 0 (S300). In addition, the threshold value calculation unit 240 initializes a variable “m” for counting each PIM signal to 1 (S301). Then, based on the reception signal acquired by the reception signal acquisition unit 232 and the information on the center frequency of the frequency band of the PIM signal output from the control unit 225, the threshold value calculation unit 240 calculates a threshold value Th(m) for the m-th PIM signal (S302). In the present embodiment, the threshold value calculation unit 240 calculates the threshold value Th(m) in the increasing order of the detuning from the center frequency of the reception band in a plurality of PIM signals.

Next, the threshold value calculation unit 240 increments the value of the variable “m” by 1 (S303). Then, the threshold value calculation unit 240 determines whether or not the value of the variable “m” exceeds the value of the total number Mmax of PIM signals output from the control unit 225 (S304). When it is determined that the value of the variable “m” does not exceed the value of the total number Mmax (“No” in S304), the threshold value calculation unit 240 again executes the process of the operation S302. Meanwhile, when the value of the variable “m” exceeds the value of the total number Mmax (“Yes” in S304), the threshold value calculation unit 240 outputs the threshold value Th(m) calculated for each PIM signal to the determination unit 231.

Next, the determination unit 231 initializes the value of the variable “m” to 1 (S305). Then, the determination unit 231 calculates the amplitude A(m) of the correction coefficient corresponding to the replica of the m-th PIM signal among the correction coefficients for each replica output from the coefficient update unit 227 (S306). The determination unit 231 calculates the amplitude A(m) of the correction coefficient in the increasing order of the detuning from the center frequency of the reception band in replicas of the plurality of PIM signals.

Next, the determination unit 231 determines whether or not the cancellation signal is abnormal by determining whether or not the value of the amplitude A(m) is equal to or larger than the threshold value Th(m) for the replica of the m-th PIM signal (S307). When it is determined that the value of the amplitude A(m) is smaller than the threshold value Th(m) (“No” in S307), the determination unit 231 increments the value of the variable “m” by 1 (S308). Then, the determination unit 231 determines whether or not the value of the variable “m” exceeds the value of the total number Mmax of replicas of the PIM signal output from the control unit 225 (S309). When it is determined that the value of the variable “m” is equal to or smaller than the value of the total number Mmax (“No” in S309), the determination unit 231 again executes the process of the operation S306.

Meanwhile, when the value of the variable “m” exceeds the value of the total number Mmax (“Yes” in S309), the determination unit 231 refers to the timer value “t” to determine whether or not the timer value “t” exceeds a value corresponding to a predetermined time T (S310). When it is determined that the timer value “t” is equal to or smaller than the value corresponding to the predetermined time T (“No” in S310), the determination unit 231 again executes the process of the operation S305. Meanwhile, when the timer value “t” exceeds the value corresponding to the predetermined time T (“Yes” in S310), the determination unit 231 again executes the process of the operation S300.

When it is determined that the value of the amplitude A(m) is equal to or larger than the threshold value Th(m) (“Yes” in S307), that is, when the cancellation signal is abnormal, the determination unit 231 increments the value of the variable “n” by 1 (S311). Then, the determination unit 231 determines whether or not the value of the variable “n” has reached a predetermined number of times Nmax (S312). When it is determined that the value of the variable “n” has not reached the predetermined number of times Nmax (“No” in S312), the determination unit 231 executes the process of the operation S308.

Meanwhile, when it is determined that the value of the variable “n” has reached the predetermined number of times Nmax (“Yes” in S312), the determination unit 231 outputs the determination result indicating the abnormality of the cancellation signal to the initialization unit 230. The initialization unit 230 outputs an initialization instruction to the coefficient update unit 227. Upon receiving the initialization instruction from the initialization unit 230, the coefficient update unit 227 initializes the correction coefficient (S313). Then, the coefficient update unit 227 resumes the updating of the correction coefficient for each replica from the initialized value. Then, the determination unit 231 again executes the process of the operation S300.

In the present embodiment as well, after the process of the operation S313 is executed, the updating of the correction coefficient by the coefficient update unit 227 may be stopped for a predetermined period of time, similarly to the processes of the operations S208 to S211 of FIG. 8. [Effects of Second Embodiment]

The second embodiment has been described. In the cancellation device 20 of the present embodiment, the determination unit 231 determines that the cancellation signal is abnormal when the amplitude of the correction coefficient is equal to or larger than the predetermined threshold value. As a result, the base station apparatus 10 may suppress the deterioration of the reception quality.

In addition, in the second embodiment, the reception signal includes a plurality of PIM signals of the same or different frequencies. The coefficient update unit 227 updates a correction coefficient for each replica based on the reception signal combined with the cancellation signal for cancelling the plurality of PIM signals included in the reception signal and each replica generated using the plurality of transmission signals. In addition, the cancellation signal generation unit 229 generates a cancellation signal by combining the respective replicas to which the updated correction coefficient is applied, with each other. The determination unit 231 sets the threshold value corresponding to the PIM signal to be lower as the center frequency of the PIM signal becomes farther from the center frequency of the reception band. As a result, the cancellation device 20 may accurately determine whether or not the amplitude of the correction coefficient becomes a divergent or nearly divergent state.

### Third Embodiment

When a plurality of PIM signals are included in the reception signal, the correction coefficient corresponding to the PIM signal with larger detuning from the center frequency of the reception band is updated so that the amplitude thereof becomes smaller. However, when the amplitude of the correction coefficient becomes the divergent or nearly divergent state, the amplitude of the correction coefficient of the PIM signal with larger detuning from the center frequency of the reception band may be larger than the amplitude of the correction coefficient of a PIM signal with smaller detuning. Therefore, the cancellation device 20 of the present embodiment determines whether or not the cancellation signal is abnormal, by determining whether or not the amplitude of the correction coefficient of the PIM signal having larger detuning from the center frequency of the reception band is larger than the amplitude of the correction coefficient of the PIM signal with smaller detuning.

[Processor 22 of Cancellation Device 20]

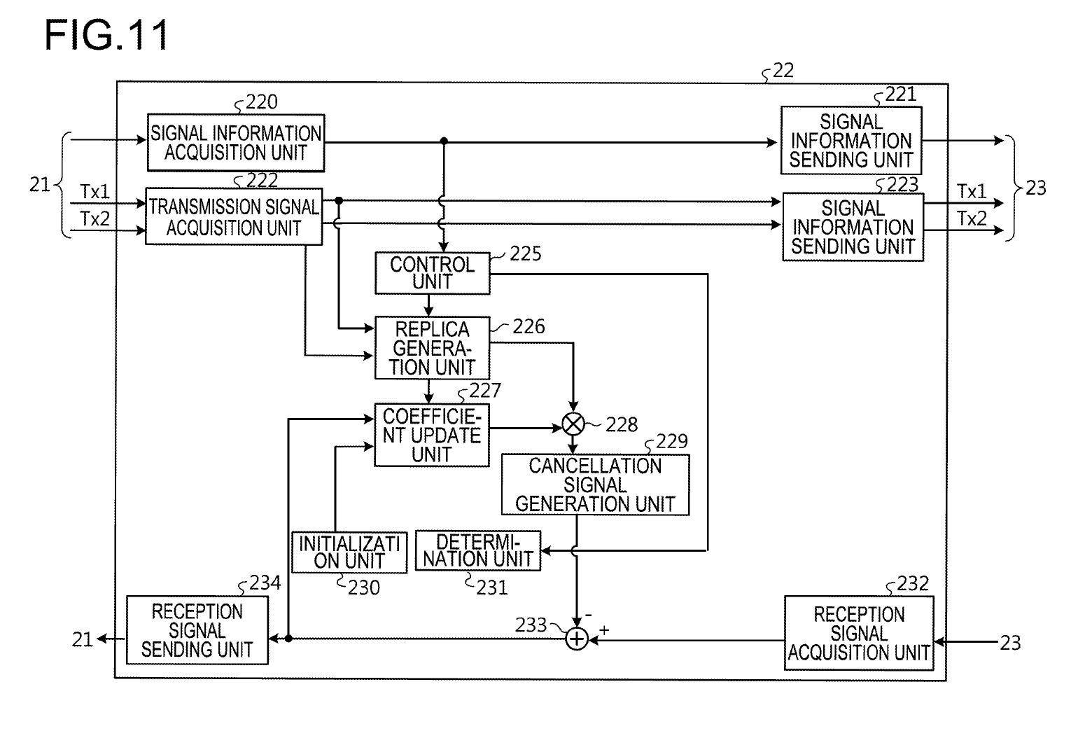

FIG. 11 is a block diagram illustrating an example of a function of a processor 22 of a cancellation device 20 according to the third embodiment. The processor 22 in the present embodiment includes a signal information acquisition unit 220, a signal information sending unit 221, a transmission signal acquisition unit 222, a transmission signal sending unit 223, a control unit 225, and a replica generation unit 226. The processor 22 in the present embodiment further includes a coefficient update unit 227, a multiplication unit 228, a cancellation signal generation unit 229, an initialization unit 230, a determination unit 231, a reception signal acquisition unit 232, a combining unit 233, and a reception signal sending unit 234. In FIG. 11, blocks denoted by the same reference numerals as those in FIG. 3 have the same or similar functions as those illustrated in FIG. 3, except for the points described below, and therefore, descriptions thereof will be omitted.

Based on the signal information output from the signal information acquisition unit 220, the control unit 225 specifies a PIM signal whose frequency band overlaps with at least a portion of the reception band. Then, the control unit 225 outputs a generation formula specified for each specified PIM signal to the replica generation unit 226. Further, the control unit 225 outputs information on the center frequency of the reception band and information on the center frequency of the frequency band of each PIM signal to the determination unit 231.

The coefficient update unit 227 updates the correction coefficient applied to each replica output from the replica generation unit 226 based on the reception signal combined with the cancellation signal. Then, the coefficient update unit 227 outputs the updated correction coefficient for each replica to the multiplication unit 228 and the determination unit 231.

The determination unit 231 determines whether or not the cancellation signal is abnormal at every predetermined timing. In the present embodiment, the determination unit 231 acquires the correction coefficient for each replica from the coefficient update unit 227 at every predetermined timing. Then, for each replica, the determination unit 231 determines whether or not the magnitude of the amplitude of the correction coefficient corresponding to the replica of a PIM signal with larger detuning from the center frequency of the reception band is equal to or larger than the magnitude of the correction coefficient corresponding to the replica of a PIM signal with smaller detuning. In any two replicas, when the magnitude of the amplitude of the correction coefficient corresponding to the replica of the PIM signal with larger detuning is equal to or larger than the magnitude of the amplitude of the correction coefficient corresponding to the replica of the PIM signal with smaller detuning, the determination unit 231 determines that the cancellation signal is abnormal. Then, when the number of times of making the determination that the cancellation signal is abnormal reaches a predetermined number of times during a predetermined period of time, the determination unit 231 outputs the determination result indicating the abnormality of the cancellation signal to the initialization unit 230.

[Abnormality Determination Process]

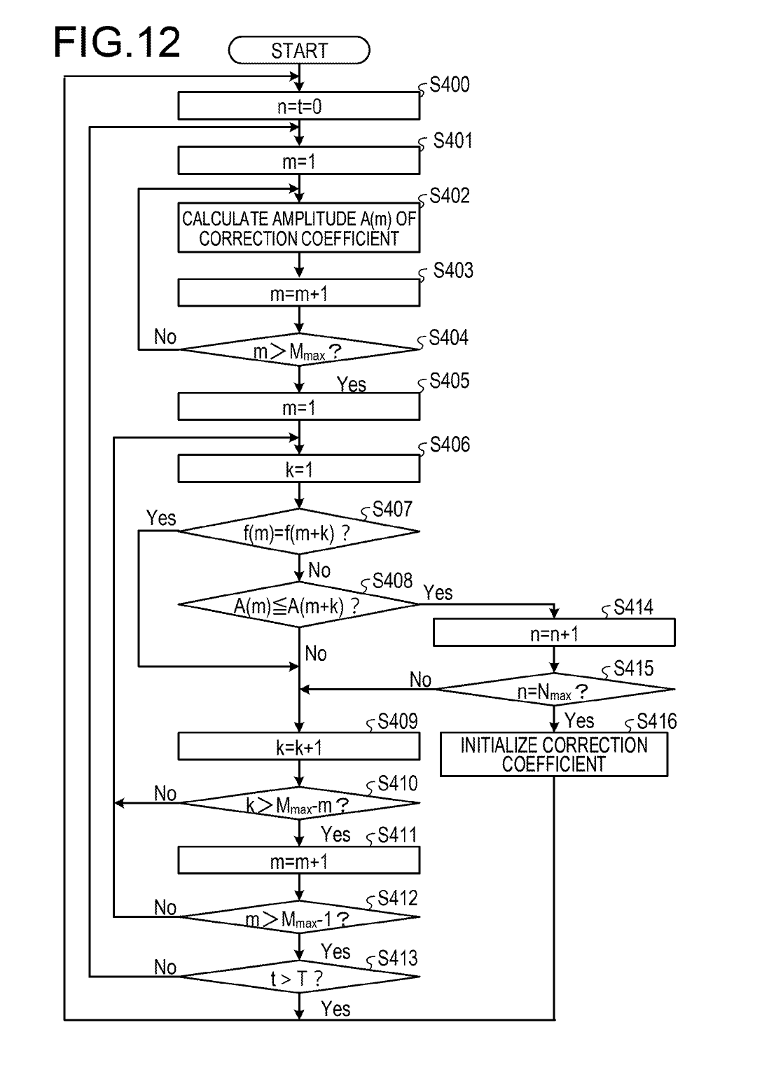

FIG. 12 is a flowchart illustrating an example of an abnormality determination process according to the third embodiment. The abnormality determination process illustrated in FIG. 12 is executed by the cancellation device 20. For example, when the operation of the base station apparatus 10 is started, the cancellation device 20 starts the operation illustrated in this flowchart.

First, the determination unit 231 initializes a variable “n” for counting the number of errors and a timer value “t” to 0 (S400). In addition, the determination unit 231 initializes a variable “m” for counting a replica of each PIM signal to 1 (S401). Then, the determination unit 231 calculates the amplitude A(m) of the correction coefficient corresponding to the replica of the m-th PIM signal among the correction coefficients for each replica output from the coefficient update unit 227 (S402). In the present embodiment, the determination unit 231 calculates the amplitude A(m) of the correction coefficient in the increasing order of the detuning from the center frequency of the reception band in replicas of the plurality of PIM signals. In addition, there are cases where PIM signals with the same detuning from the center frequency of the reception band exist among the plurality of PIM signals.

Next, the determination unit 231 increments the value of the variable “m” by 1 (S403). Then, the determination unit 231 determines whether or not the value of the variable “m” exceeds the value of the total number Mmax of replicas of the PIM signals output from the control unit 225 (S404). When it is determined that the value of the variable “m” does not exceed the value of the total number Mmax (“No” in S404), the determination unit 240 again executes the process of the operation S402.

Meanwhile, when it is determined that the value of the variable “m” exceeds the value of the total number Mmax (“Yes” in S404), the determination unit 231 initializes the value of the variable “m” to 1 (S405) and initializes the value of a variable “k” to 1 (S406). Then, the determination unit 231 determines whether or not the center frequency f(m) of the m-th PIM signal is equal to the center frequency f(m+k) of the (m+k)-th PIM signal (S407). When it is determined that the center frequency f(m) of the PIM signal and the center frequency f(m+k) of the PIM signal are equal to each other (“Yes” in S407), the process of the operation S408 is skipped and the determination unit 231 executes the process of the operation S409.

Meanwhile, when it is determined that the center frequency f(m) of the PIM signal and the center frequency f(m+k) of the PIM signal are different from each other (“No” in S407), the determination unit 231 executes the process of the operation S408. In other words, the determination unit 231 determines whether or not the cancellation signal is abnormal, by determining whether or not the value of the amplitude A(m) corresponding to the replica of the m-th PIM signal is equal to or smaller than the value of the amplitude A(m+k) corresponding to the replica of the (m+k)-th PIM signal (S408). In the operation S408, it is determined whether or not the amplitude of the correction coefficient of the replica of the PIM signal with larger detuning from the center frequency of the reception band is equal to or smaller than the amplitude of the correction coefficient of the replica of the PIM signal with smaller detuning.

When it is determined that the value of the amplitude A(m) is larger than the value of the amplitude A(m+k) (“No” in S408), the determination unit 231 increments the value of the variable “k” by 1 (S409). Then, the determination unit 231 determines whether or not the value of the variable “k” exceeds a value obtained by subtracting the value of the variable “m” from the value of the total number Mmax of replicas (S410). When it is determined that the value of the variable “k” is equal to or smaller than the value obtained by subtracting the value of the variable “m” from the value of the total number Mmax (“No” in S410), the determination unit 231 again executes the process of the operation S406. As a result, the amplitude of the correction coefficient corresponding to the replica of the m-th PIM signal and the amplitude of the correction coefficient corresponding to the replica of the PIM signal with larger detuning from the center frequency of the reception band than that of the m-th PIM signal are sequentially compared with each other.

Meanwhile, when it is determined that the value of the variable “k” exceeds the value obtained by subtracting the value of the variable m from the value of the total number Mmax (“Yes” in S410), the determination unit 231 increments the value of the variable “m” by 1 (S411). Then, the determination unit 231 determines whether or not the value of the variable “m” exceeds a value obtained by subtracting one from the value of the total number Mmax of replicas (S412). When it is determined that the value of the variable “m” is equal to or smaller than the value obtained by subtracting one from the value of the total number Mmax (“No” in S412), the determination unit 231 again executes the process of the operation S406.

Meanwhile, when it is determined that the value of the variable “m” exceeds the value obtained by subtracting one from the value of the total number Mmax (“Yes” in S412), the determination unit 231 refers to the timer value “t” to determine whether or not the timer value “t” exceeds a value corresponding to a predetermined time T (S413). When it is determined that the timer value “t” is equal to or smaller than the value corresponding to the predetermined time T (“No” in S413), the determination unit 231 again executes the process of the operation S401. Meanwhile, when it is determined that the timer value “t” exceeds the value corresponding to the predetermined time T (“Yes” in S413), the determination unit 231 again executes the process of the operation S400.

When it is determined that the value of the amplitude A(m) is equal to or smaller than the value of the amplitude A(m+k) (“Yes” in S408), that is, when it is determined that the cancellation signal is abnormal, the determination unit 231 increments the value of the variable “n” by 1 (S414). Then, the determination unit 231 determines whether or not the value of the variable “n” has reached a predetermined number of times Nmax (S415). When it is determined that the value of the variable “n” has not reached the predetermined number of times Nmax (“No” in S415), the determination unit 231 executes the process of the operation S409.

Meanwhile, when it is determined that the value of the variable “n” has reached the predetermined number of times N max (“Yes” in S415), the determination unit 231 outputs the determination result indicating the abnormality of the cancellation signal to the initialization unit 230. The initialization unit 230 outputs an initialization instruction to the coefficient update unit 227. Upon receiving the initialization instruction from the initialization unit 230, the coefficient update unit 227 initializes the correction coefficient (S416). Then, the coefficient update unit 227 resumes the updating of the correction coefficient for each replica from the initialized value. Then, the determination unit 231 again executes the process of the operation S400.

In the present embodiment as well, after the process of the operation S416 is executed, the updating of the correction coefficient by the coefficient update unit 227 may be stopped for a predetermined period of time, similarly to the processes of the operations S208 to S211 of FIG. 8.

### Effects of Third Embodiment

The third embodiment has been described. In the present embodiment, the reception signal includes a plurality of PIM signals of the same or different frequencies. The coefficient update unit 227 updates a correction coefficient for each replica based on the reception signal combined with the cancellation signal for cancelling the plurality of PIM signals included in the reception signal and each replica generated using the plurality of transmission signals. The cancellation signal generation unit 229 generates a cancellation signal by combining the respective replicas to which the updated correction coefficient is applied, with each other. For the replica corresponding to each PIM signal, when the amplitude of the correction coefficient does not become smaller as the center frequency of the PIM signal becomes farther from the center frequency of the frequency band of the reception signal, the determination unit 231 determines that the cancellation signal is abnormal. As a result, the cancellation device 20 may accurately determine whether or not the amplitude of the correction coefficient becomes the divergent or nearly divergent state.

[Others]

In addition, the present disclosure is not limited to the above-described embodiments but various modifications may be made without departing from the scope of the gist of the present disclosure.

For example, in each of the embodiments described above, when receiving an initialization instruction from the initialization unit 230, the coefficient update unit 227 initializes the correction coefficient for each replica to a correction coefficient having amplitude and phase values of 0. However, the present disclosure is not limited thereto. For example, when receiving an initialization instruction from the initialization unit 230, the coefficient update unit 227 may initialize the correction coefficient for each replica to a correction coefficient having amplitude and phase values each of which is a predetermined value other than 0. As a result, the coefficient update unit 227 may quickly converge the correction coefficient to a desired value in updating the initialized correction coefficient.

In addition, the coefficient update unit 227 may frequently hold the correction coefficient updated before a predetermined period of time, and when receiving the initialization instruction from the initialization unit 230, initialize the correction coefficient to the correction coefficient held for each replica. As a result, the coefficient update unit 227 may more quickly converge the correction coefficient to a desired value in updating the initialized correction coefficient.

In each of the embodiments described above, the base station apparatus 10 has been described as an example of a wireless communication apparatus, but the present disclosure is not limited thereto. The technique described in each of the embodiments may be applied to, for example, a terminal device.

Further, in each of the embodiments described above, the respective processing blocks of the base station apparatus 10 are classified by function according to the main processing contents in order to facilitate the understanding of the base station apparatus 10. Therefore, the present disclosure is not limited by the method of the classification of the processing blocks or the names of the processing blocks. The respective processing blocks of the base station apparatus 10 in the above-described embodiments may be further divided into more processing blocks according to the processing contents, or the plurality of processing blocks may be integrated into one processing block. For example, the function of the initialization unit 230 of the processor 22 of the cancellation device 20 may be included in the coefficient update unit 227 or the determination unit 231. In addition, the processes executed by the respective processing blocks may be implemented as processes by software or may be implemented by dedicated hardware such as ASIC (Application Specific Integrated Circuit).

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. A cancellation device comprising:
a memory; and
a processor coupled to the memory and the processor configured to:
acquire a plurality of transmission signals to be wirelessly transmitted having mutually different frequencies;
acquire a reception signal to which a plurality of inter-modulated signals generated by the plurality of transmission signals wirelessly transmitted are added;
update a correction coefficient based on a signal obtained by combining a cancellation signal, to be applied to the reception signal, with an inter-modulated signal of the plurality of inter-modulated signals included in the reception signal, and a replica signal of the inter-modulated signal generated by the plurality of transmission signals;
apply the correction coefficient to the replica signal so as to generate the cancellation signal; and
initialize the correction coefficient based on a relationship between the cancellation signal and the reception signal.

2. The cancellation device according to claim 1,
wherein the processor is configured to initialize the correction coefficient when a power of the cancellation signal is equal to or higher than the power of the reception signal.

3. The cancellation device according to claim 1,
wherein the processor is configured to initialize the correction coefficient when the amplitude of the correction coefficient is equal to or larger than a predetermined value.

4. The cancellation device according to claim 3,
wherein the processor is configured to:
update the correction coefficient for each of replica signals, based on signals obtained by combining the cancellation signal with the plurality of inter-modulated signals included in the reception signal, and each of the replica signals generated by the plurality of transmission signals,
generate the cancellation signal by combining each of the replica signals to which the updated correction coefficient is applied, and
wherein the predetermined value corresponding to each of the inter-modulated signals is set to be low as the center frequency of the inter-modulated signal becomes farther from the center frequency of the frequency band of the reception signal.

5. The cancellation device according to claim 1,
wherein the reception signal includes a plurality of inter-modulated signals of the same or different frequencies, and
wherein the processor is configured to
update the correction coefficient for each of replica signals, based on a signal obtained by combining the plurality of inter-modulated signals included in the reception signal with the cancellation signal, and each of the replica signals generated by the plurality of transmission signals,
generate the cancellation signal by combining each of the replica signals to which the updated correction coefficient is applied, and
determine that the correction coefficient is to be initialized when the amplitude of the correction coefficient of the replica signal corresponding to the inter-modulated signal does not become smaller as the center frequency of the inter-modulated signal becomes farther from the center frequency of the frequency band of the reception signal for the replica signal corresponding to the inter-modulated signal.

6. The cancellation device according to claim 5,
wherein, when the processor determines that the correction coefficient is to be initialized, the processor is configured to stop an operation of updating the correction coefficient for a predetermined period of time, and resume the operation of updating the correction coefficient from initializing correction coefficient after a lapse of the predetermined period of time.

7. The cancellation device according to claim 6,
wherein, when the processor determines that a number of times of making a determination that the correction coefficient is to be initialized reaches a predetermined number of times, the processor is configured to initialize the correction coefficient.

8. A cancellation method comprising:
acquiring a plurality of transmission signals to be wirelessly transmitted at different frequencies;
acquiring a reception signal to which a plurality of inter-modulated signals generated by the plurality of transmission signals wirelessly transmitted are added;
updating a correction coefficient based on a signal obtained by combining a cancellation signal with an inter-modulated signal of the plurality of inter-modulated signals included in the reception signal, and a replica signal generated by the plurality of transmission signals;
applying the correction coefficient to the replica signal so as to generate the cancellation signal; and
initializing the correction coefficient based on a relationship between the cancellation signal and the reception signal, by a processor.

9. A wireless communication apparatus comprising:
a transmitter configured to transmit a plurality of transmission signals so as to be wirelessly transmitted at different frequencies;
a receiver configured to receive a reception signal to which a plurality of inter-modulated signals generated by the plurality of transmission signals wirelessly transmitted are added;
a memory; and
a processor coupled to the memory and the processor configured to:
update a correction coefficient based on a signal obtained by combining a cancellation signal with an inter-modulated signal of the plurality of inter-modulated signals included in the reception signal, and a replica signal generated by the plurality of transmission signals;
apply the correction coefficient to the replica signal so as to generate the cancellation signal; and
initialize the correction coefficient based on a relationship between the cancellation signal and the reception signal.

10. The wireless communication apparatus according to claim 9,
wherein the processor is further configured to:
generate a distortion signal having a reverse characteristic of a distortion component generated in an amplifier, based on an input signal input to the amplifier and a feedback signal of an output signal output from the amplifier, and
add the distortion signal to the input signal.
